(19) United States
(12) Patent Application Publication
(10) Pub. No.: US 2012/0224397 A1
(43) Pub. Date: Sep. 6, 2012

(54) DEVICES AND METHODS OF CONSTANT OUTPUT CURRENT AND VOLTAGE CONTROL FOR POWER SUPPLIES

(76) Inventor: Wen-Chung Edward Yeh, Taipei (TW)

(21) Appl. No.: 13/083,595

(22) Filed: Apr. 11, 2011

(30) Foreign Application Priority Data
Mar. 4, 2011 (TW) 100107264

(51) Int. Cl. H02M 3/335

(52) U.S. Cl. 363/21.12

(57) ABSTRACT

Power controllers, control methods and related integrated circuits for power supplies are disclosed. A power supply has a power switch and an inductive device. An exemplifying power controller comprises a first current source, a discharge time sensor, a representative current generator, and a pulse width modulator. The first current source generates a target current pouring to a compensation node. The discharge time sensor determines a discharge time of the inductive device. The representative current generator generates a representative current representing an inductor current of the inductive device. The pulse width modulator determines an output power of the power supply according to the compensation voltage at the compensation node. The representative current drains from the compensation node during the discharge time.

### CROSS-REFERENCE TO RELATED APPLICATIONS

This non-provisional application claims priority under 35 U.S.C. §119(a) on Patent Application No(s). 100107264 filed in Taiwan, R.O.C. on Mar. 4, 2011, the entire contents of which are hereby incorporated by reference.

### BACKGROUND

This invention relates to power supplies and methods used therein.

Constant output current and voltage control is an object that lots of power supplies would like to approach. For instance, as of a battery charger, an output to a battery is generally designed to provide a constant output current for charging the battery, and to provide a constant output voltage after the battery is fully charged. Similarly, as of the applications of lighting, a power supply should output a constant output current when lighting is ON and a constant voltage when lighting is OFF.

FIG. 1 is a conventional power supply 10, a flyback converter. Bridge rectifier 12 rectifies the current from the alternating-current (AC) power grid line to generate a direct-current (DC) line voltage V_{IN} at line voltage node IN. Transformer 14 has primary winding prm, secondary winding sec, and auxiliary winding aux. Power controller 18, here embodied by a monolithic integrated circuit, has pin GATE to turn ON or OFF power switch 15. Hereinafter, turning a switch ON means making the switch a short circuit, and turning it OFF means making it an open circuit. When power switch 15 is ON, transformer 14 is energized by line voltage V_{IN} at line voltage node IN; and when power switch 15 is OFF, it discharges its energy to build up output voltage V_{OUT} at output node OUT. Output voltage V_{OUT} renders, through voltage-dividing resistors, feedback voltage V_{FB}, which is forwarded to LT431 for comparing with 2.5 volt, a target voltage set in LT431. The comparison result is accumulated at pin COM, which is connected to an external compensation capacitor 25. Power controller 18 could detect the completion of discharge of transformer 14, through pin ZCD and voltage-dividing resistors 26 and 28. Current sense resistor 24 senses the current through power switch 15 or primary winding prm.

The inventor of this application has disclosed in a US patent application, numbered as US20100321956, herein incorporated by reference in its entirety, several constant output current and voltage control means for power supplies. Simplicity, in view of both architecture and circuitry, is what circuit designers pursue all the time.

### SUMMARY

Embodiments of the present invention provide a power controller, formed in an integrated circuit, suitable for a power supply having a power switch and an inductive device. The power controller comprises a first current source, a discharge time sensor, a representative current generator, and a pulse width modulator. The first current source generates a target current pouring to a compensation node. The discharge time sensor detects a discharge time of the inductive device. The representative current generator generates a representative current representing an inductor current of the inductive device. The pulse width modulator determines an output power of the power supply according to the compensation voltage at the compensation node. The representative current drains from the compensation node during the discharge time.

Embodiments of the present invention provide a constant output current and voltage control method, suitable for a power supply having a power switch to periodically control an inductor current of an inductive device. A feedback voltage is provided to represent an output voltage of the power supply. The inductor current is detected to generate a representative current. The feedback voltage is compared with a target voltage to generate a target current. The target current pours to a compensation node. The representative current drains from the compensation node during a period of time. The period of time is determined by detecting the inductive device. The output power of the power supply is determined using the compensation voltage at the compensation node.

Embodiments of the present invention provide a control method, suitable for a power supply having a power switch to periodically switch an inductive device. A compensation node is provided. A target current pours into the compensation node. During a discharge time of the inductive device, a representative current drains from the compensation node. A compensation voltage at the compensation node is compared with a ramp signal to determine an output power of the power supply. The representative current represents an average inductor current during the discharge time.

Embodiments of the present invention provide an integrated circuit, suitable for a power supply comprising a power switch, an inductive device and an external compensation capacitor. The power switch is switched at a switch cycle time. The integrated circuit comprises a compensation pin, and a pulse width modulator. The compensation pin is for being connected to the external compensation capacitor. The pulse width modulator determines an output power of the power supply according to the compensation voltage at the compensation pin. Through the compensation pin, the integrated circuit charges in a period of time and discharges in another period of time the external compensation capacitor during the switch cycle time.

### BRIEF DESCRIPTION OF THE DRAWINGS

The invention can be more fully understood by the subsequent detailed description and examples with references made to the accompanying drawings, wherein:

FIG. 1 is a conventional power supply;

FIG. 2 exemplifies an embodiment of this invention, applicable to the power supply of FIG. 1;

FIGS. 3A and 3B exemplify output voltage comparator and output current comparator of FIG. 2;

FIG. 4 shows waveforms of signals related to FIGS. 3A and 3B;

FIGS. 5A, 5B, 5C, 5D and 5E are examples for the pulse width modulator of FIG. 2;

FIG. 6 illustrates a power supply with primary side control according to an embodiment of the invention;

FIG. 7 exemplifies the power controller of FIG. 6 and employs the architecture taught in FIG. 2;

FIG. 8 shows signal V_{ZCD} and feedback voltage V_{FB} that is a sampled result of signal V_{ZCD} during discharge time;

FIG. 9 exemplifies a constant-output-current-and-voltage power supply, which the architecture of FIG. 2 can be employed to;

FIG. 10 exemplifies the power controller of FIG. 9; and

FIG. 11 shows waveforms of some signals in FIGS. 9 and 10.

### DETAILED DESCRIPTION

Further objects of the present invention and more practical merits obtained by the present invention will become more apparent from the description of the embodiments which will be given below with reference to the accompanying drawings. For explanation purposes, components with equivalent or similar functionalities are represented by the same symbols. Hence components of different embodiments with the same symbol are not necessarily identical. Here, it is to be noted that the present invention is not limited thereto.

Even though the following embodiments of the invention are flyback converters, the scope of the invention is not limited to. Persons skilled in the art could apply the invention to other converters, such as boosters, buck converters, buck-boosters, and so forth, based on the teaching disclosed herein this specification.

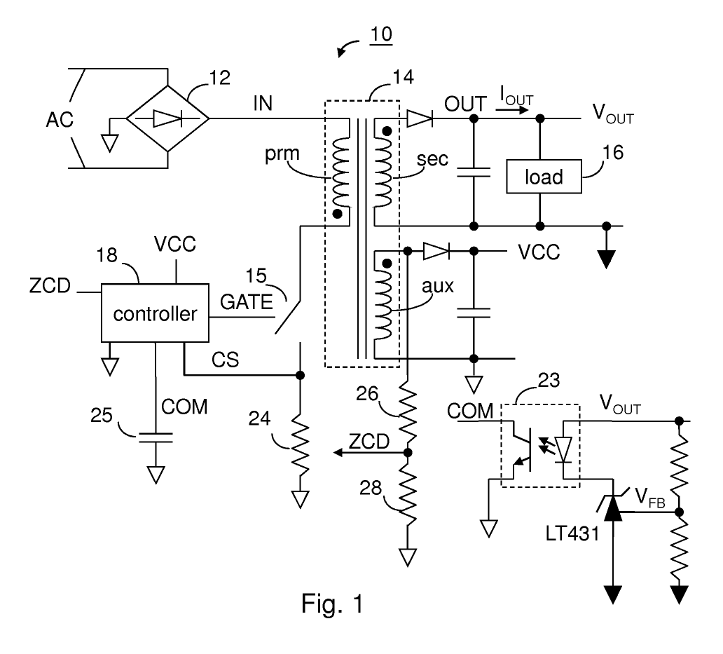

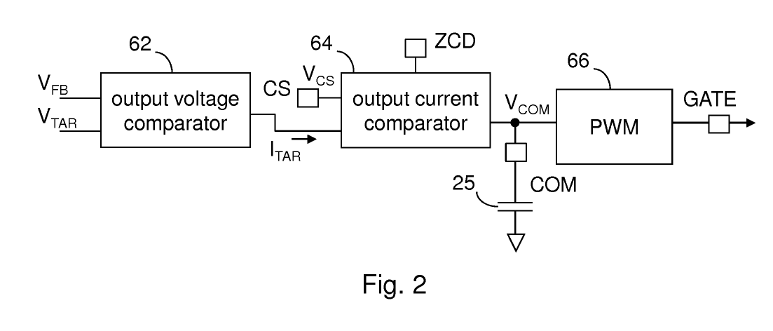

FIG. 2 exemplifies an embodiment of this invention, applicable to the power supply of FIG. 1, to analyze how the constant output current and voltage control is achieved. FIG. 1 is not used to limit the scope of the invention, nevertheless. In one embodiment, output voltage comparator 62, output current comparator 64, and pulse-width modulator 66 in FIG. 2 are all formed in a monolithic integrated circuit. In another embodiment, nevertheless, parts of the three devices in FIG. 2 are formed in a monolithic IC, while the others are formed by discrete components.

In FIG. 2, output voltage comparator 62 compares feedback voltage V_{FB} with target voltage V_{TAR} to generate target current I_{TAR}. Feedback voltage V_{FB}, as shown in the example of FIG. 1, correspondingly represents output voltage V_{OUT}. Target current I_{TAR} has a maximum value I_{MAX}. Receiving signals from pins CS and ZCD, together with target current I_{TAR}, output current comparator 64 generates compensation voltage V_{COM} at compensation node of pin COM. Pin COM could be optionally connected to an external compensation capacitor 25. Via pulse-width modulator 66, compensation voltage V_{COM} determines the output power of a power supply. Here for pulse-width modulator 66, determining means there is a one-to-one correspondence. A certain value of compensation voltage V_{COM} corresponds to a certain output power of the power supply when other factors or variables are substantially fixed. The higher compensation voltage V_{COM}, the more the output power. What compensation voltage V_{COM} decides to power switch 15 could be the ON time, the OFF time, the switching frequency, or the combination thereof, to determine the output power of a power supply.

Output current comparator 64 functions to make, through pulse-width modulator 66, output current I_{OUT} at output node OUT approach a target value I_{OUT-TAR} correspondingly defined by target current I_{TAR}. Based on the teaching in US20100321956, average output current I_{SEC-AVG} from secondary winding sec can be calculated from the waveforms at pins CS and ZCD to know whether it exceeds target value I_{OUT-TAR}. Equivalently, output current comparator 64 compares average output current I_{SEC-AVG} with target value I_{OUT-TAR} and the comparison result is accumulated at pin COM to update compensation voltage V_{COM}, such that output power (from secondary winding sec) in subsequent switching cycles is modified to make average output current I_{SEC-AVG} approach target value I_{OUT-TAR}.

When load 16 of FIG. 1 is heavy enough, output voltage comparator 62 keeps target current I_{TAR} at the maximum value I_{MAX} because feedback voltage V_{FB} is constantly below target voltage V_{TAR}. As a result, output current comparator 62 controls compensation voltage V_{COM} to make output current I_{OUT} approach maximum output current I_{OUT-MAX} corresponding to the maximum value I_{MAX}, thereby achieving constant current control. When load 16 of FIG. 1 is light or null, output voltage comparator 62 tunes target current I_{TAR} based on the difference between feedback voltage V_{FB} and target voltage V_{TAR}, and output current comparator 64 makes output current I_{OUT} approach target value I_{OUT-TAR} (corresponding to target current I_{TAR}). It can be derived that target current I_{TAR} is updated to make feedback voltage V_{FB} substantially approach target voltage V_{TAR}, thereby achieving constant output voltage control. It also can be derived from the above analysis that both signal paths of the constant voltage control loop (comprising output voltage comparator 62) and the constant current control loop (comprising output current comparator 64) pass pin COM.

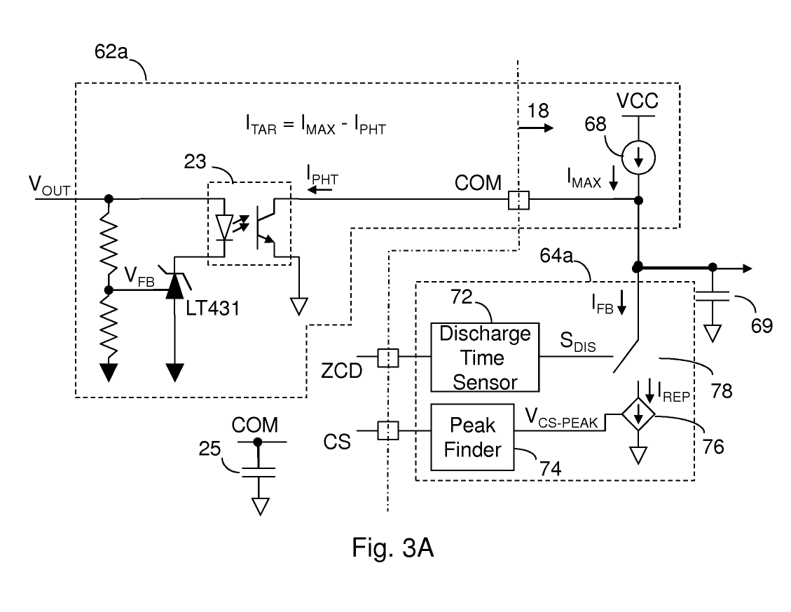

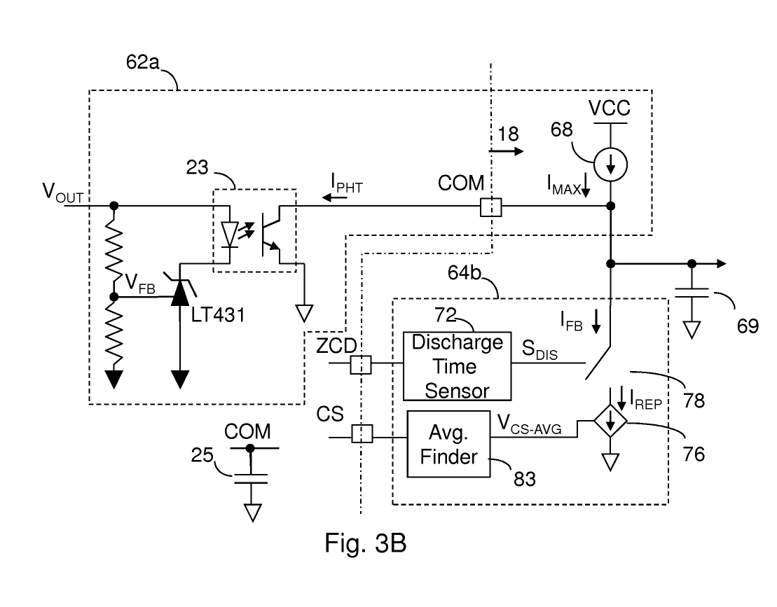

FIG. 3A exemplifies output voltage comparator 62 and output current comparator 64. As shown in FIG. 3A, there is a constant current source 68 inside power controller 18 providing current with a current value of I_{MAX}. All components in output voltage comparator 62a but constant current 68 are all disclosed in FIG. 1 and should be self-explanatory to persons skilled in the art, such that they are not detailed in consideration of brevity. Simply put, output voltage comparator 62a can be deemed to be a transconductor or a voltage-controlled current source that compares feedback voltage V_{FB} with 2.5 v (a target voltage defined by LT431) to generate target current I_{TAR} whose value is I_{MAX} minus I_{PHT}, where I_{PHT} is the leakage current drained by photo coupler 23 and is never negative. Leakage current I_{PHT} is not zero when feedback voltage V_{FB} exceeds 2.5 v. Accordingly, the maximum value of target current I_{TAR} is I_{MAX}.

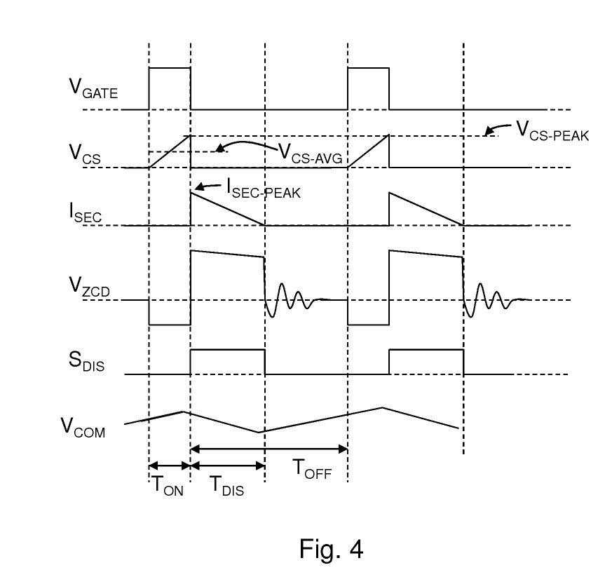

As shown in FIG. 3A, output current comparator 64a has discharge time sensor 72 and peak finder 74. Discharge time sensor 72 senses signal V_{ZCD} at pin ZCD to determine discharge time T_{DIS} of secondary winding sec and generate signal S_{DIS}. Peak finder 74 senses current sense signal V_{CS} at pin CS to generate peak signal V_{CS-PEAK}, which represents a peak voltage of current sense signal V_{CS} and also substantially represents peak discharge current I_{SEC-PEAK} of secondary winding sec. During discharge time T_{DIS,} switch 78 is ON, such that representative current I_{REP} that voltage-controlled current source 76 converts from peak signal V_{VCS-PEAK} drains from pin COM. Feedback current I_{FB} represents the average of representative current I_{REP} over a switch cycle time, and can be derived to equal (I_{REP}*T_{DIS})/(T_{ON}+T_{OFF}) where ON time T_{ON}, OFF time T_{OFF}, and discharge time T_{DIS} are exemplified in FIG. 4, which shows peak signal V_{CS-PEAK}, peak discharge current I_{SEC-PEAK} and waveforms of signals related to FIG. 3A. Representative current I_{REP} corresponds to peak current I_{CS PEAK} flowing through primary winding prm, which corresponds to average inductor current I_{CS-AVG} of primary winding during ON time T_{ON}, which corresponds to average discharge current I_{SEC-AVG} of secondary winding sec during discharge time T_{DIS}. As a result, representative current I_{REP} corresponds to, or represents, average discharge current I_{SEC-AVG}, and, in this embodiment, voltage-controlled current source 76 together with peak finder 74 can be deemed as a representative current generator. Regarding to discharge time sensor 72 and peak finder 74, US patent application publication No. US20100321956 discloses several examples and details their operations. It can be derived from the teaching of US20100321956 and the teaching in this specification that feedback current I_{FB} of FIG. 3A is substantially in proportion to output current I_{OUT} of FIG. 1.

As can be derived from FIG. 3A, during discharge time IDIS in a switch cycle time, external compensation capacitor 25 and internal compensation capacitor 69 are discharged or drained by the current of representative current I_{REP} deducted by target current I_{TAR}. Internal compensation capacitor 69 could be, for example, the parasitic capacitor residing at a bonding pad of a pin in an integrated circuit. In a switch cycle time other than discharge time T_{DIS}, the two compensation capacitors are poured or charged by target current I_{TAR}. In case that the value of target current I_{TAR} is I_{MAX}, the two compensation capacitors are discharged by a constant current in one period of time and charged by another constant current in another period of time.

Please refer to FIGS. 1, 2 and 3A. Output voltage comparator 62a can be deemed to be a voltage-controllable current source generating target current I_{TAR}. Based upon the teaching of US20100321956 and the disclosure regarding to FIGS. 1, 2 and 3A, persons skilled in the art can derive the variation of compensation voltage V_{COM} at compensation pin COM over time and the analysis how compensation voltage V_{COM} controls pulse width modulator 66 to achieve constant output current and voltage control. In FIG. 3A, both external compensation capacitor 25, which is outside power controller 18, and internal compensation capacitor 69, which is inside power controller 18, provide low-pass filtering. If internal compensation capacitor 69 has capacitance large enough to stabilize the output current I_{OUT} and voltage V_{OUT} at output node OUT of FIG. 1, external compensation capacitor 25 might be omitted in some embodiments of the invention.

It is known in the art that, as taught by Yang in the cover page of U.S. Pat. No. 7,352,595, to provide constant output current and voltage control, two external compensation capacitors each having considerable capacitance are needed, providing compensations to stabilize a constant voltage control loop and a constant current loop, respectively. Accordingly, the control circuit 70 in the cover page of U.S. Pat. No. 7,352,595, if formed as an integrated circuit, needs two compensation pins COMI and COMV. Different from the teaching of Yang, the embodiment of FIG. 3A of this specification, if large capacitance is required for compensation, needs only one single compensation pin COM to connect to an external compensation capacitor and to compensate both the constant output current loop and the constant output voltage loop. As shown in FIG. 3A, external compensation capacitor 25, if existing, directly low-passes the comparison result generated by comparing feedback voltage V_{FB} with 2.5 v (a target voltage), and, at the same time, directly low-passes the comparison result generated by comparing feedback current I_{FB} with target current I_{TAR}. Thus, a power supply having the circuit of FIG. 3A might be very suitable to applications where feedback current I_{FB} or feedback voltage V_{FB} varies largely. For instance, an embodiment of the invention is the power supply of FIG. 1, employing the circuits shown in FIGS. 2 and 3A, having a power factor correction (PFC) technique, and providing a constant output current and voltage control. In one embodiment, power controller 18 in FIG. 1 is a monolithic integrated circuit having only 6 pins: VCC, GND, GATE, ZCD, COM and CS. In another embodiment, power controller 18 has more than 6 pins.

FIG. 3B exemplifies output voltage comparator 62 and output current comparator 64. The common features between FIGS. 3B and 3A could be comprehensible according to the aforementioned teaching and are not detailed in view of brevity. Different to FIG. 3A, output current comparator 64b has average finder 83, which generates average signal V_{CS-AVG}. Average signal V_{CS-AVG}, as shown in FIG. 4, represents average current I_{CS-AVG} flowing through power switch 15 over ON time T_{ON}. Two exemplified average finders can be found in the FIGS. 17 and 18 of US20100321956. Based on US20100321956, FIGS. 1, 2, and 3B of this specification, and the teaching thereof, persons skilled in the art can understand how compensation voltage V_{COM} at pin COM of FIG. 3B varies to affect pulse width modulator 66 and to achieve constant output current and voltage control.

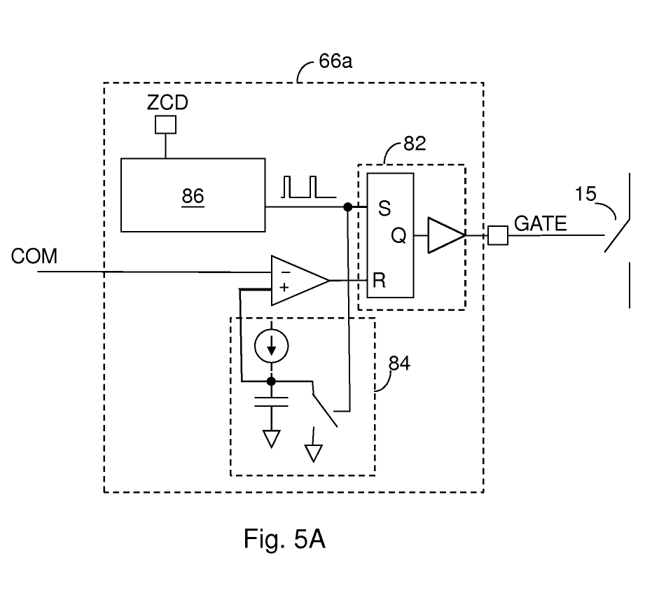

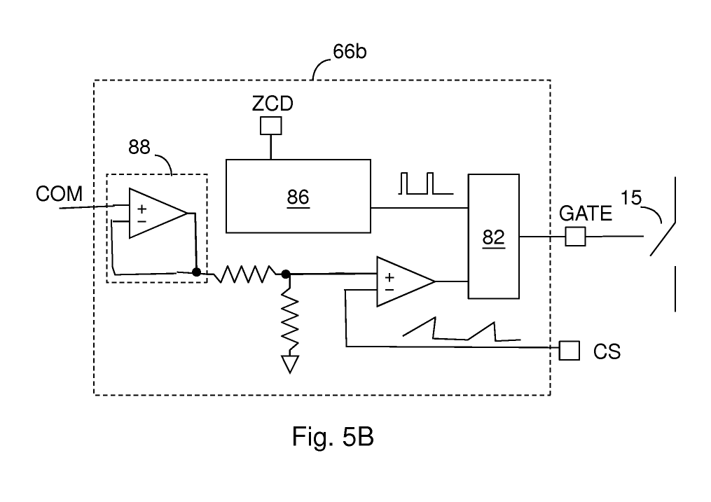

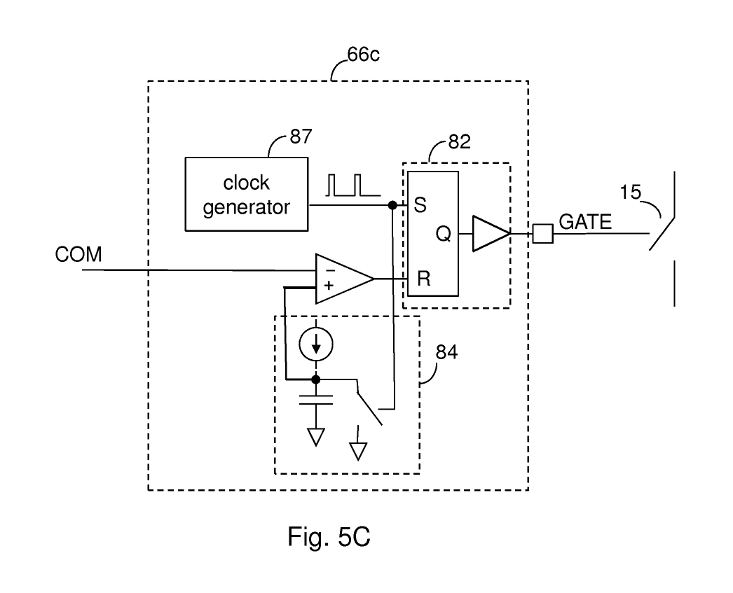

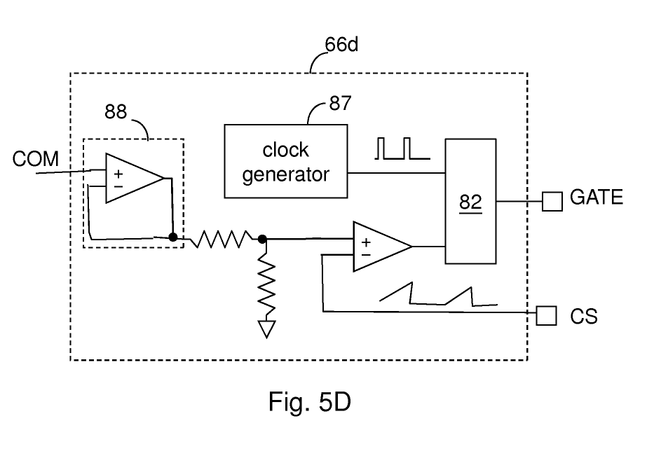

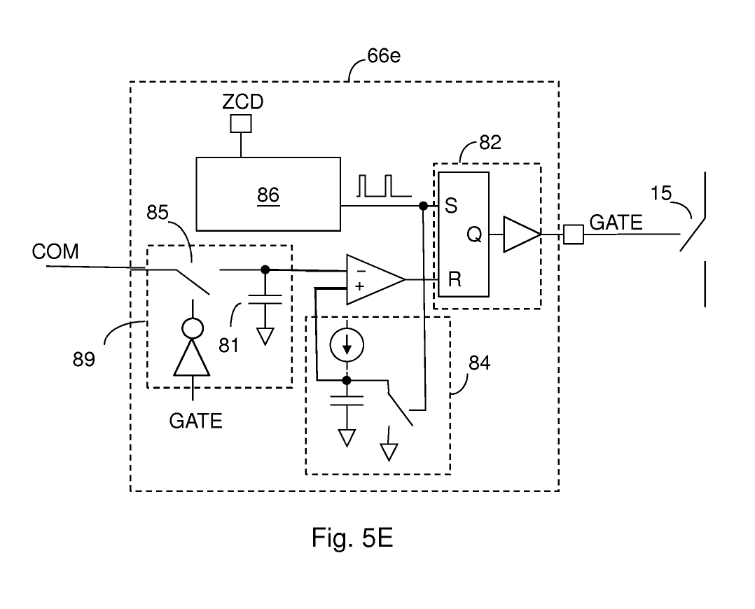

FIGS. 5A, 5B, 5C, 5D and 5E are examples for pulse width modulator 66 of FIG. 2, which might be embodied by other circuits and is not limited to the illustrated examples.

Of pulse width modulator 66a in FIG. 5A, zero current detector 86 generates a short pulse to turn ON, through logic controller 82, power switch 15 and reset ramp signal generator 84 at the same time, when the end of discharge time T_{DIS} is detected. When ramp signal outputted from ramp signal generator 84 exceeds compensation voltage V_{COM}, logic controller 82 turns power switch 15 off. In FIG. 5A, ON time T_{ON} when an inductive device energizes substantially starts right after the end of discharge time T_{DIS} is detected, and this kind of operation mode is known as transition mode, boundary mode or critical mode. There are two other operation modes: continuous conduction mode (CCM) and discontinuous conduction mode (DCM). Generally speaking, CCM refers to that ON time T_{ON} starts even though an inductive device has not completely discharged. DCM refers to that ON time T_{ON} does not start until a considerable period of time lapses after the end of discharge time T_{DIS}. In FIG. 5A, ON time T_{ON} of power switch 15 is substantially determined by compensation voltage V_{COM} and is independent from line voltage V_{IN} at line voltage node IN. This kind of control is commonly referred to voltage mode control. Pulse width modulator 66a might be employed in a PFC power supply.

FIG. 5B shares features common with FIG. 5A which are comprehensible for persons skilled in the art and are not restated here in consideration of brevity. In FIG. 5B, voltage buffer 88 provides a high impedance input to pin COM and substantially duplicates compensation voltage V_{COM} at its own output node. It can be derived from FIG. 5B that compensation voltage V_{COM} at pin COM substantially defines the peak value of current sense signal V_{CS} and that ON time T_{ON} depends on line voltage V_{IN} at line voltage node IN. This kind of control is commonly referred to current mode control.

FIG. 5C illustrates pulse width modulator 66c, which, similar with pulse width modulator 66a of FIG. 5A, employs voltage mode control. Unlike FIG. 5A, FIG. 5C has clock generator 87 periodically turning ON power switch 15 through logic controller 82, such that pulse width modulator 66c could operate in CCM, boundary mode, or DCM. Similarly, FIG. 5D illustrates pulse width modulator 66d which has the same components with those in pulse width modulator 66b of FIG. 5B except clock generator 87. Therefore, FIG. 5D could operate in CCM, boundary mode or CCM.

FIG. 5E illustrates pulse width modulators 66e, an alternative of pulse width modulators 66a in FIG. 5A. Sampling circuit 89 is inserted and connected between a comparator and pin COM. During ON time T_{ON} when power switch 15 is ON, switch 85 performs an open circuit, isolating pin COM and holding capacitor 81, such that the voltage of holding capacitor 81 substantially remains a constant. During OFF time T_{OFF} when power switch 15 is OFF, the voltage of holding capacitor 81 follows compensation voltage V_{COM} at pin COM. The same sampling circuit 89 could be inserted between a comparator and pin COM of any one pulse width modulator in FIGS. 5B-5D, to come out other variant. Adding sampling circuit 89 therein could diminish or depress sub-harmonic oscillation.

If a power supply operates in DCM, discharge time sensor can determine discharge time T_{DIS} by sensing the time when signal V_{ZCD} drops across zero. If a power supply operations in CCM, discharge time T_{DIS} is substantially equal to OFF time T_{OFF} of power switch 15, and determining discharge time T_{DIS} might not require sensing signal V_{ZCD}.

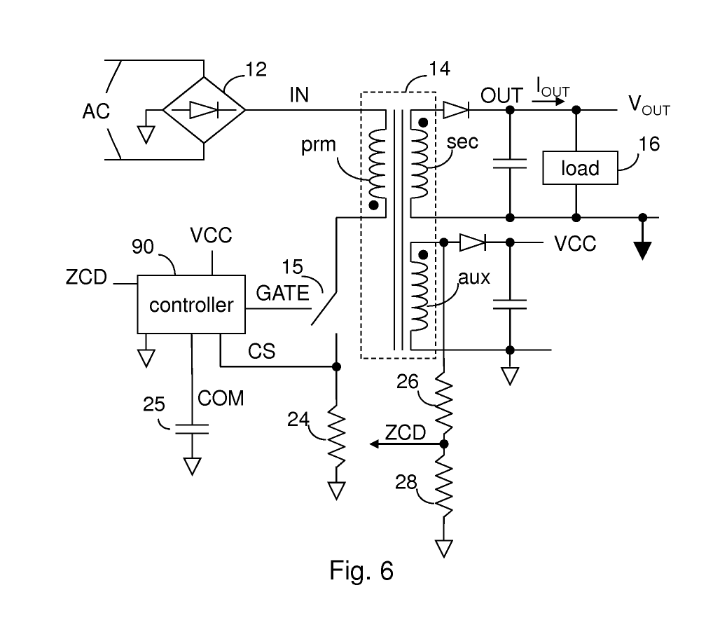

FIG. 6 illustrates a constant output voltage and current power supply with primary side control, which is substantially the same with the FIG. 1 of US20100321956 but has different labels, such that explanation of FIG. 6 is omitted herein for brevity. Output voltage comparator 62, output current comparator 64, and pulse width modulator 66 of FIG. 2 can also be applied to the power supply in FIG. 6.

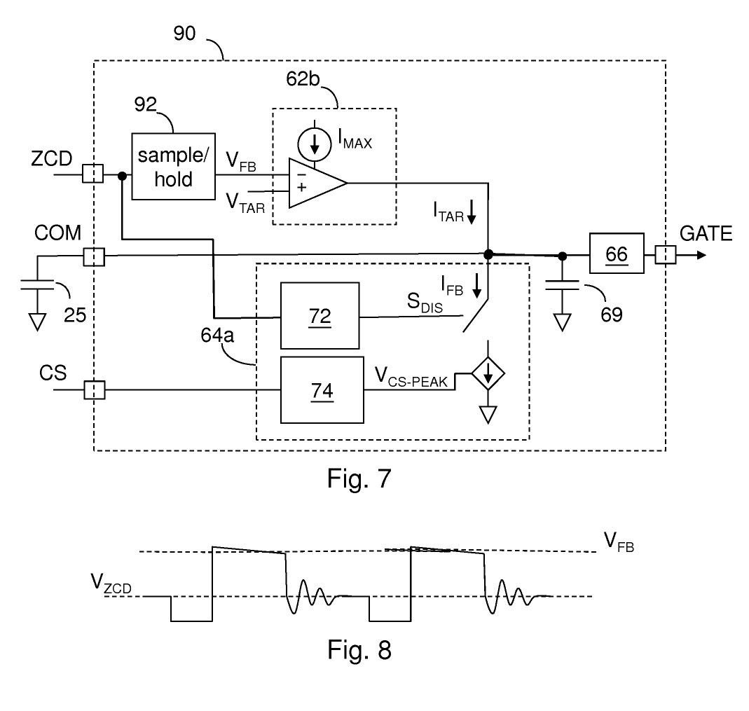

FIG. 7 exemplifies power controller 90 of FIG. 6 and employs the architecture taught in FIG. 2. In one embodiment, power controller 90 is a monolithic integrated circuit, having sample/hold circuit 92, output voltage comparator 62b, output current comparator 64a, and pulse width modulator 66. Sample/hold circuit 92 samples signal V_{ZCD} at pin ZCD during discharge time T_{DIS} to generate feedback voltage V_{FB}, as shown in FIG. 8. It can be derived by persons skilled in the art that feedback voltage V_{FB} has a certain relationship with output voltage V_{OUT} and can substantially represent output voltage V_{OUT}.

Output voltage comparator 62b compares feedback voltage V_{FB} with target voltage V_{TAR} to generate target current I_{TAR}. As shown in FIG. 7, output voltage comparator 62b could be a transconductor outputting target current I_{TAR,} whose value is in proportion to the difference between target voltage V_{TAR} and feedback voltage V_{FB} and whose maximum is I_{MAX}.

Output current comparator 64a, as aforementioned, compares feedback current I_{FB} with target current I_{TAR} to control compensation voltage V_{COM}, which in turn controls power switch 15 of FIG. 6 via pulse width modulator 66 to make feedback current I_{FB} approach target current I_{TAR}, thereby achieving constant output current control.

It can be derived by persons skilled in the art that power controller 90 of FIG. 7, similar with power controller 18 of FIG. 1, could achieve constant output current and voltage control, could low-pass filter output voltage and current comparison results using one single external compensation capacitor, could be embodied in an integrated circuit with a 6-pin package, and could be suitable for PFC power supplies. What FIG. 7 differs from FIG. 3 includes that, in FIG. 7, power controller 90 having output voltage comparator 62b could be embodied in an monolithic integrated circuit, employing primary side control, while, in FIG. 3A, output voltage comparator 62a has several discrete electric devices formed outside power controller 18 (an integrated circuit), employing secondary side control.

In another embodiment, peak finder 74 of FIG. 7 is replaced by average finder 83 of FIG. 3B, while the other elements of FIG. 7 remain the same.

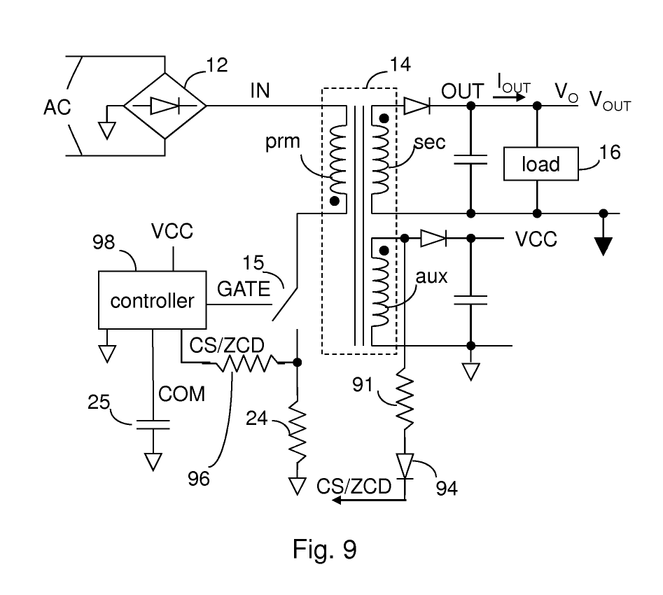

FIG. 9 exemplifies a constant output current and voltage power supply, which employs the circuit architecture of FIG. 2. Portions of FIG. 9 similar to or the same with those of FIG. 6 are not detailed herein for brevity. In one embodiment, power controller 98 is embodied by a monolithic integrated circuit in a package having at least 5 pins: VCC, COM, CS/ZCD, GATE, and GND. Generally speaking, the less the pin number, the cheaper the integrated circuit, the smaller the product volume, and the more competitive the product.

In FIG. 9, coupled between pin CS/ZCD and auxiliary winding aux are diode 94 and resistor 91 coupled in series. Coupled Between pin CS/ZCD and current sense resistor 24 is resistor 96. Via pin CS/ZCD, power controller 98 can detect the inductor current flowing through power switch 15, feedback voltage V_{FB} representing output voltage V_{OUT}, and discharge time T_{DIS}. Thus, pin CS/ZCD is a multi-functional pin.

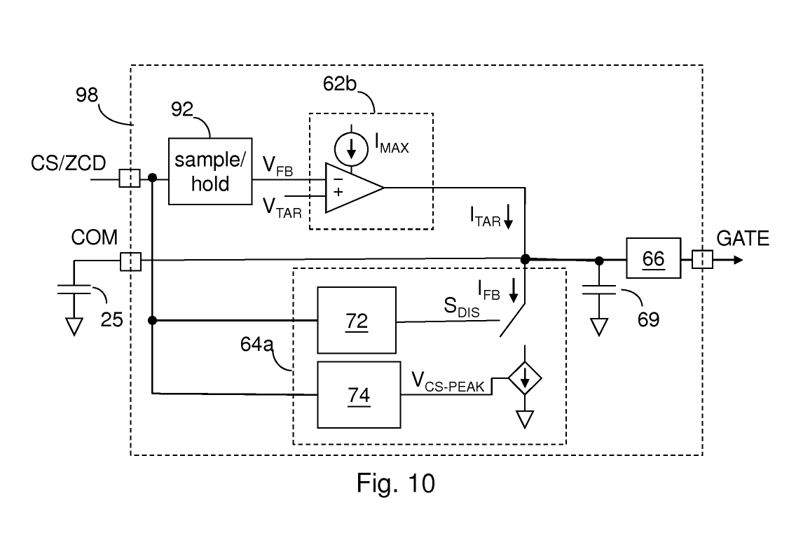

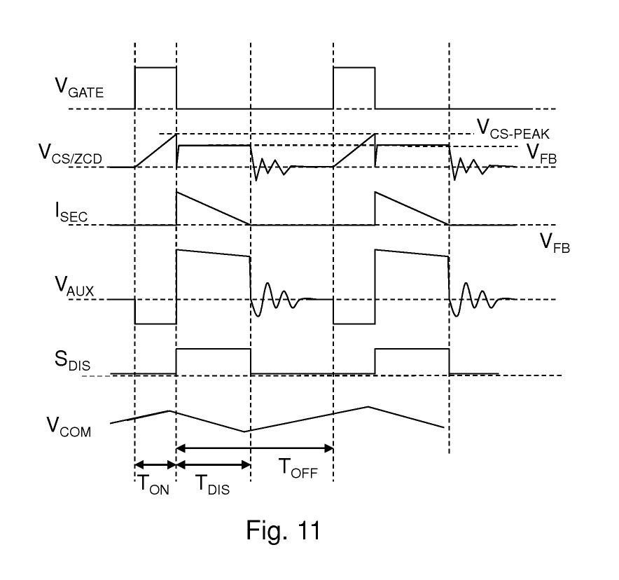

FIG. 10 exemplifies power controller 98 of FIG. 9. Unlike power controller 90 of FIG. 7, in which sample/hold circuit 92 and output current comparator 64a detect signals from two different pins, sample/hold circuit 92 and output current comparator 64a of FIG. 10 are commonly coupled to one single pin CS/ZCD to detect information. FIG. 11 shows waveforms of some signals in FIGS. 9 and 10, wherein V_{CS/ZCD} denotes voltage signal at pin CS/ZCD. When power switch 15 is ON, diode 94 is reversely biased, signal V_{CS/ZCD} represents the inductor current flowing through power switch 15 and primary winding prm, and, accordingly, peak signal V_{CS-PEAK} denoted in FIG. 11 represents the peak current flowing through primary winding prm. During discharge time T_{DIS} when power switch 15 is OFF and secondary winding sec conducts current, diode 94 of FIG. 9 is forward biased, and signal V_{AUX} at one terminal of auxiliary winding aux, which represents output voltage V_{OUT} too, renders a corresponding signal V_{CS/ZCD} at pin CS/ZCD using voltage dividing function provided by resistors 91, 96 and current sense resistor 24. Accordingly, sample/hold circuit 92 of FIG. 10 can obtain feedback voltage V_{FB} by sampling the voltage at pin CS/ZCD, and discharge time sensor 72 of FIG. 10 can find discharge time T_{DIS} from the signal at pin CS/ZCD. It can be derived by persons skilled in the art how power controller 98 of FIG. 10 achieves constant output current and voltage control based on the aforementioned teaching. FIG. 10 performs primary side control since feedback voltage V_{FB} are generated by sensing the reflective voltage across auxiliary winding aux.

In another embodiment, all the components of FIG. 10 remain except peak finder 74 is replaced by average finder 83 of FIG. 3B.

In another embodiment, the primary side control performed in FIG. 10 is changed into secondary side control, where sample/hold circuit 92 and output voltage comparator 62b of FIG. 10 are omitted or disabled, and what is added to FIG. 10 is output voltage comparator 62a of FIG. 3A or 3B, which is connected to pin COM and has discrete devices, such as voltage dividing resistors, LT431, and photo coupler, used for output voltage V_{OUT} detection and comparison.

It can be derived based on the aforementioned embodiments that discharge time T_{DIS} is the time period when current is supplied to output load. Taking FIG. 4 as an example, I_{zec}, the very current flowing through secondary winding sec and the only current supplied to load 16 (of FIG. 1), is not zero only during discharge time T_{DIS}. Thus, driving time T_{DRV}, when load is driven by a power supply, is equal to discharge time T_{DIS}. Nevertheless, for some other power supply topologies, driving time T_{DRV} might be longer than discharge time T_{DIS}. In one embodiment of the invention, driving time T_{DRV} might include ON time T_{ON} and discharge time T_{DIS} such that a corresponding output current comparator shall use signal S_{DRV} (indicating driving time T_{DRV}) instead of signal S_{DIS} (indicating discharge time T_{DIS}) to control the timing of draining a compensation capacitor. For instance, representative current I_{REP} drains pin COM during discharge T_{DIS} for power controllers applicable to flyback converters. Nevertheless, for power controllers applicable to buck converters, representative current I_{REP} drains pin COM during both discharge T_{DIS} and ON time T_{ON}.

Embodiments of the invention might be applicable to lighting power supplies with function of dimming, where the value of the constant output current is controlled by a dimming signal. Taking FIG. 3A for example, to provide dimming function, the maximum value I_{MAX} might be controlled by a dimming signal. In one embodiment, between constant current source 68 and pin COM of FIG. 3A has a dimming switch controlled by a dimming signal, when the dimming signal turn the dimming switch ON, current of the maximum value I_{MAX} is poured into pin COM by constant current source 68, and when the dimming signal turn the dimming switch OFF, pin COM is not poured by constant current source. Accordingly, the maximum of target current I_{TAR} becomes I_{MAX}*D, where D is the duty ratio of the dimming signal. In another embodiment, of FIG. 7 between pin COM and the transconductor in output voltage comparator 62b has a dimming switch controlled by a dimming signal, which provides or stops target current I_{TAR} pouring to pin COM. It can be derived that the maximum of target current I_{TAR} is also I_{MAX}*D.

In the above embodiments, discharge time T_{DIS} is, but is not limited to be, determined by sensing the timing when signal V_{ZCD} at pin ZCD drops across 0V, as demonstrated in FIG. 4. Another method to determine discharge time T_{DIS} could be implemented by slightly modifying the circuit shown in FIG. 7. In one embodiment, discharge time sensor 72 of FIG. 7 is replaced by another discharge time sensor which generates discharge time signal S_{DIS} according to feedback signal V_{FB} and peak signal V_{CS-PEAK}, because discharge time T_{DIS} theoretically is in proportion to the magnitude of peak signal V_{CS-PEAK} divided by the magnitude of feedback signal V_{FB}.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power controller, formed in an integrated circuit, suitable for a power supply having a power switch and an inductive device, the power controller comprising:
a first current source, for generating a target current pouring to a compensation node;
a discharge time sensor, for determining a discharge time of the inductive device;
a representative current generator, for generating a representative current representing an inductor current of the inductive device; and
a pulse width modulator for determining an output power of the power supply according to the compensation voltage at the compensation node;
wherein the representative current drains from the compensation node during the discharge time.

2. The power controller of claim 1, wherein the first current source is a transconductor generating the target current according to the difference between a feedback voltage and a target voltage, and the target current has a predetermined maximum value.

3. The power controller of claim 1, wherein the first current source is a constant current source.

4. The power controller of claim 1, further comprising:
a current sense pin, through which the representative current generator is capable of sensing the inductor current; and
an auxiliary pin, through which the discharge time sensor determines the discharge time.

5. The power controller of claim 1, further comprising:
a multi-function pin, through which the representative current generator and the discharge time sensor detects the inductor current and the discharge time, respectively.

6. The power controller of claim 1, comprising:
a peak detector, for detecting the inductor current to generate a peak signal representing a peak current of the inductor current;
wherein the representative current is generated according to the peak signal.

7. The power controller of claim 1, wherein the compensation node is connected to a compensation pin of the integrated circuit, and the compensation pin is optionally connected to an external compensation capacitor.

8. The power controller of claim 7, wherein the switched mode power supply has a constant voltage control loop passing through the compensation pin.

9. The power controller of claim 1, wherein the pulse width modulator compares the compensation voltage with a ramp signal to control the power switch.

10. A control method, suitable for a power supply having a power switch to periodically control an inductor current of an inductive device, the control method comprising:
providing a feedback voltage representing an output voltage of the power supply;
detecting the inductor current to generate a representative current;
comparing the feedback voltage with a target voltage to generate a target current; and
pouring the target current to a compensation node and draining the representative current from the compensation node during a driving time, wherein the driving time includes a discharge time of the inductive device.

11. The control method of claim 10, wherein the discharge time of the inductive device is an OFF time of the power switch.

12. The constant output current and voltage control method of claim 10, further comprising:
determining the output power of the power supply using the compensation voltage at the compensation node.

13. A control method, suitable for a power supply having a power switch to periodically switch an inductive device, the control method comprising:
providing a compensation node;
pouring a target current into the compensation node;
during a driving time including a discharge time of the inductive device, draining a representative current from the compensation node; and
comparing a compensation voltage at the compensation node with a ramp signal to determine an output power of the power supply;
wherein the representative current represents an average inductor current during the discharge time.

14. The control method of claim 13, the control method further comprising:
comparing a feedback voltage and a target voltage to generate the target current;
wherein the target current has a predetermined maximum value.

15. The control method of claim 13, further comprising:
comparing a feedback voltage with a target voltage; and
draining a leakage current from the compensation node when the feedback voltage is over the target voltage;
wherein the feedback voltage substantially corresponds to an output voltage of the power supply.

16. An integrated circuit, suitable for a power supply comprising a power switch, an inductive device and an external compensation capacitor, wherein the power switch is switched at a switch cycle time, the integrated circuit comprising:
a compensation pin, for being connected to the external compensation capacitor; and
a pulse width modulator, for determining an output power of the power supply according to the compensation voltage at the compensation pin;
wherein, through the compensation pin, the integrated circuit charges in a period of time and discharges in another period of time the external compensation capacitor during the switch cycle time.

17. The integrated circuit of claim 16, wherein the power supply has a transconductor comparing a feedback voltage and a target voltage, and the transconductor has an output coupled to the compensation pin.

18. The integrated circuit of claim 17, wherein the transconductor is formed in the integrated circuit.

19. The integrated circuit of claim 16, further comprising a discharge time sensor for determining a discharge time of the inductive device.

20. The integrated circuit of claim 19, wherein the integrated circuit discharges the external compensation capacitor during the discharge time.
